(19) United States
(12) Patent Application Publication
(10) Pub. No.: US 2007/0272170 A1
(43) Pub. Date: Nov. 29, 2007

(54) THERAPEUTIC PET JACKET AND BED

(76) Inventors: Carl Dutrisac Milson, Gravenhurst (CA); Shane Patrick Carr, Gravenhurst (CA)

Correspondence Address: SCHMEISER, OLSEN & WATTS, 22 CENTURY HILL DRIVE, SUITE 302, LATHAM, NY, 12110, US

(21) Appl. No.: 11/458,730

(22) Filed: Jul. 20, 2006

(30) Foreign Application Priority Data
May 23, 2006 (CA) 2547458

(51) Int. Cl. A01K 13/00

(52) U.S. Cl. 119/850

(57) ABSTRACT

A pet jacket and bed which possesses pockets therein for receiving removably insertable gel packs or grain (oatmeal) packs, which packs can be heated up or cooled as necessary so as to provide hot and cold therapies for convalescent arthritic pets, pets with injuries or which can simply alter temperature and comfort for the pet.

### FIELD OF THE INVENTION

This invention relates to, in general, to the field of pet accessories and care. More specifically, the present invention is directed to a pet jacket and bed that holds removably insertable gel packs or grain (oatmeal) packs, which packs can be heated up or cooled as necessary so as to provide hot and cold therapies for convalescent arthritic pets, pets with injuries or which can simply alter temperature and comfort for the pet.

### DESCRIPTION OF THE PRIOR ART

Generally speaking, the comfort needs of pets usually are tended to by the caring owner. Such needs include proper nutrition, routine health care, veterinary needs, pre-operation and post-operation needs, sanitation needs, recreational needs, and resting needs. Pets can suffer from discomfort, such as heat, cold, pain, sore muscles, arthritis, injuries and any myriad of other physical discomforts and ailments which may or may not require veterinary attention.

It is known to provide heated animal beds so as to provide pets with relief from these types of discomfort. However, there are few, if any, safe and convenient devices for this purpose. For example, most commercially available heated beds contain electrical heating elements surrounded by insulation and padding, much like heating pads for humans. However, there are several disadvantages when attempting to use these devices with animals. The most obvious danger is that the animal may chew through the padding, exposing the animal to the risk of electrocution.

Another problem with heated animal beds is the likelihood of producing regions of localized heat, often referred to as “hot spots.” Unlike humans, who can simply turn down the temperature of a heating pad if it is too hot, animals cannot regulate the temperature of their heated bed. Since this apparatus is used while the animal is asleep, the animal may not even realize that the bed is too hot. This exposes the animal to possible burns, and if severe enough, even death. Furthermore, “hot spots” are a fire hazard. Pet owners often place bedding on top of the animal bed to provide comfort for the animal. Some bedding sold in pet stores is not capable of withstanding high temperatures. Exposing this bedding to such regions of localized heat may cause it to catch fire.

Certain prior commercial products have attempted to solve this problem by embedding the heating element in plastic. However, this greatly lowers the efficiency of the heater, thereby increasing the cost of operating the bed. Other products have attached the heating element to the base of the bed. This leaves a gap between the top of the bed and the heating element which can be filled with air or water. This also lowers the efficiency of the heater because much of the heat is transmitted to the base, thus never reaching the animal. Furthermore, the addition of water adds a substantial amount of weight to the bed, making it less mobile.

Thus, there is a need for an improved therapeutic pet jacket and bed that holds removably insertable cooling or heating elements (such as gel packs or grain (oatmeal) packs), which elements can be heated up or cooled as necessary so as to provide hot and cold therapies for convalescent arthritic pets, pets with injuries or which can simply alter temperature and comfort for the pet. In this regard, the present invention substantially fulfills this need.

### SUMMARY OF THE INVENTION

Accordingly, one object of the present invention is to provide an improved therapeutic pet jacket and bed that is simple to use, which is safe, and which can provide hot and cold therapies for pets.

Another object of the present invention is to provide an improved therapeutic pet jacket and bed that holds removably insertable cooling or heating elements (such as gel packs or grain (oatmeal) packs), which elements can be heated up or cooled as necessary so as to provide hot and cold therapies for pets.

According to one aspect of the present invention, there is provided a pet jacket comprising a coat which substantially covers a pet's body, the coat having at least one pocket formed on an inner surface thereof; and means for securing the coat to the pet's body.

According to another aspect of the present invention, there is provided a pet jacket comprising a coat which substantially covers a pet's body, the coat having at least one pocket formed on an inner surface thereof, wherein the at least one pocket is operably able to receive and support a removable temperature adjustment element placed therein; and means for securing the coat to the pet's body.

A still further aspect of the present invention provides for a pet bed comprising opposed front and rear panels, each of the panels being defined by an edge portion, the front and rear panels being connected together along a substantial length of the edge portion of each panel to form at least one pocket therein and a receiving opening in the formed pocket for insertion and removal of a removable cooling or heating element in the at least one pocket such that a pet may have a temperature controlled pet bed.

The advantage of the present invention is that it provides an improved therapeutic pet jacket and bed that is simple to use, which is safe, and which can provide hot and cold therapies for pets.

A further advantage of the present invention is that it provides an improved therapeutic pet jacket and bed that holds removably insertable cooling or heating elements (such as gel packs or grain (oatmeal) packs), which elements can be heated up or cooled as necessary so as to provide hot and cold therapies for pets.

### BRIEF DESCRIPTION OF THE DRAWINGS

A preferred embodiment of the present invention is described below with reference to the accompanying drawings, in which:

FIG. 1 is a top view of an underside of an embodiment of the pet jacket of the present invention, the underside being secured around the body of a pet, such as a dog; and

FIG. 2 is a bottom view of an embodiment of the pet bed of the present invention.

### DESCRIPTION OF THE PREFERRED EMBODIMENT

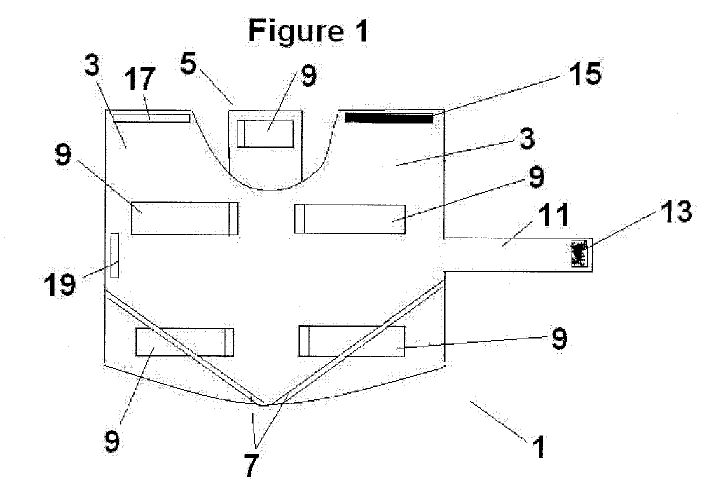

FIG. 1 broadly illustrates an embodiment of the underside of the pet jacket 1 of the present invention. In placing the jacket on a pet, such as a dog, the animal's rear hind legs are inserted through each of straps 7, with shoulder portions 3 and neck portion 5 being positioned on top of these respective areas of the animal. It should be noted that the jacket also comprises a plurality of pockets 9 on the underside of the jacket, which, when the jacket is placed on the animal, will be in contact with the pet. These pockets, of course, are designed to receive the cooling or heating elements placed therein, such as gel packs or grain packs, which can be heated or cooled as necessary to provide hot and cold therapies for pets.

As can be seen in FIG. 1, the pockets are inserted at the crucial target areas of the hips, shoulders and neck. It will, of course, be understood that other variations to this arrangement of the pockets are possible, as would be apparent to one skilled in the art. When heat is applied (through use of a heated pack, for example), the blood flow to that area is increased, improving the flow of nutrients and oxygen to the muscles, and helping to heal the damaged tissue. Consequently, there is a decreases in pain and stiffness, and an increase in flexibility and comfort. When the use of a cold pack is effected, the cold applied reduces the circulation in the underlying tissue, easing inflammation, muscle spasms and pain. Alternating between heat and cold therapy can promote healing of damaged tissues also, easing pain and discomfort for the pet.

To secure the jacket to an animal, and when the jacket is placed on the upper surface of the pet, waist strap portion 11 is placed under and around the stomach animal, wherein velcro portions 13 is then secured unto velcro receiving member 19. One of the shoulder portions 3 will also possess a second velcro member 15, which is then attached to second velcro receiving member 17, so as to securely position the jacket to the upper portion of the pet. It will be understood that variations to this securement arrangement other than velcro securement are possible, as would be apparent to one skilled in the art. For example, it is conceivable that a detachable harness could also be used for securing the coat to the animal, the harness being attached to the coat.

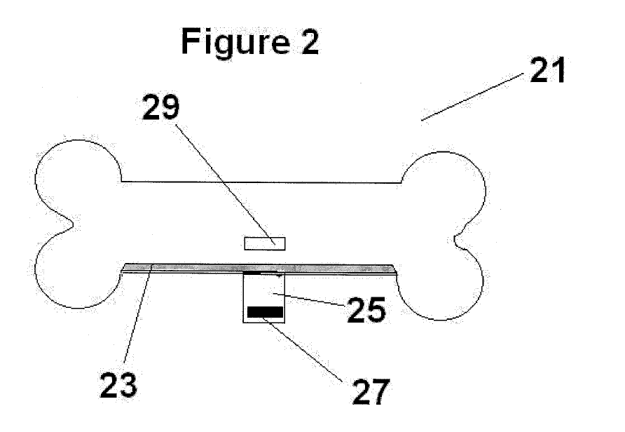

With reference to FIG. 2, there is provided another embodiment of the present invention, the pet bed, which utilizes internal pockets for receiving cooling or heating elements placed therein, such as gel packs or grain packs to provide hot and cold therapies for pets. In this embodiment, the bed is “bone shape”, though other configurations are of course possible. Preferably, the bed will be 6-8″ thick, though, of course, other variations as to this are possible. In the preferred embodiment, the bed 21 is formed from textile sheet material and comprises opposed front and rear panels (not shown), each of the panels being defined by an edge portion. The front and rear panels are connected along the edge portion of each panel by a stitched seam to form a pocket therebetween, and a receiving opening 23 is provided on an outer surface of the bed for the insertion and removal in the pocket of the cooling or heating elements placed therein, such as gel packs or grain packs, which can be heated or cooled as necessary to provide hot and cold therapies for pets.

Once the cooling or heating elements are placed therein, the receiving opening 23 to the bed 21 can be sealed by utilizing securing strip 25, which has, preferably, velcro strip member 27 thereon, this being secured onto velcro receiving member 29. To unseal the opening 23, of course, velcro strip member 27 is disengaged from velcro receiving member 29, securing strip 25 is peeled back, and access to the receiving opening 23 can be effected, whereby the cooling or heating elements in the pocket can be removed. Of course, it will be understood that variations to the securement arrangement of the receiving opening of the bed are possible, as would be apparent to one skilled in the art. It will also be understood that, in forming the bed from textile sheet material, that a plurality of pockets could be formed on an inner surface thereof, each of the plurality of pockets being operably able to receive and support removably insertable cooling or heating elements placed therein.

It will also be understood to one skilled in the art that, instead of utilizing an internal pocket or pockets formed between the sewn together panels of material, that pockets could also be formed on a exterior surface of the upper panel of material, each of which being operably able to receive and support removably insertable cooling or heating elements placed therein.

The present invention has been described herein with regard to preferred embodiments. However, it will be obvious to persons skilled in the art that a number of variations and modifications can be made without departing from the scope of the invention as described herein.

The embodiments of the invention in which an exclusive property or privilege is claimed are defined as follows:

1. A pet jacket comprising:
a coat which substantially covers a pet's body, the coat having at least one pocket formed on an inner surface thereof; and
means for securing the coat to the pet's body.

2. The pet jacket of claim 1, wherein the coat is comprised of a substantially durable material.

3. The pet jacket of claim 1, wherein the coat further comprises a plurality of pockets formed on the inner surface thereof, each of the plurality of pockets being operably able to receive and support a removable temperature adjustment element placed therein.

4. The pet jacket of claim 1, wherein the at least one pocket is operably able to receive and support a removable temperature adjustment element placed therein.

5. A pet jacket comprising:
a coat which substantially covers a pet's body, the coat having at least one pocket formed on an inner surface thereof, wherein the at least one pocket is operably able to receive and support a removable temperature adjustment element placed therein; and
means for securing the coat to the pet's body.

6. The pet jacket of claim 5, wherein the coat further comprises a plurality of pockets formed on the inner surface thereof, each of the plurality of pockets being operably able to receive and support a removable temperature adjustment element placed therein.

7. The pet jacket of claim 1, wherein the temperature adjustment element is a gel pack.

8. The pet jacket of claim 1, wherein the temperature adjustment element is a grain pack.

9. The pet jacket of claim 1, wherein the means for securing the coat to the pet's body is a detachable harness, the harness being attached to the coat.

10. The pet jacket of claim 1, wherein the means for securing the coat to the pet's body is through velcro strips positioned on the coat.

11. A pet bed comprising:
opposed front and rear panels, each of the panels being defined by an edge portion, the front and rear panels being connected together along a substantial length of the edge portion of each panel to form at least one pocket therein; and
a receiving opening in the formed pocket for insertion and removal of a removable cooling or heating element in the at least one pocket such that a pet may have a temperature controlled pet bed.
a housing having a top wall, a bottom wall, and side walls connecting the top and bottom walls, the housing defining an inner cavity, and having at least one pocket formed therein for receiving and positioning a removable cooling or heating element inserted therein such that a pet may have a temperature controlled pet bed.

12. The pet bed of claim 11, wherein the at least one pocket is formed on an inner surface of the housing.

13. The pet bed of claim 11, wherein the cooling or heating element is a gel pack.

14. The pet bed of claim 11, wherein the cooling or heating element is a grain pack.

15. The pet bed of claim 11, wherein the connected front and rear panels further comprise a plurality of pockets formed on an inner surface thereof, each of the plurality of pockets being operably able to receive and support removably insertable cooling or heating elements placed therein.

16. The pet bed of claim 11, wherein the connected front and rear panels comprise at least one pocket formed on an outer surface thereof.

17. The pet bed of claim 11, wherein the connected front and rear panels comprise a plurality of pockets formed on an outer surface thereof, each of the plurality of pockets being operably able to receive and support removably insertable cooling or heating elements placed therein.
